(19) United States
(12) Patent Application Publication
(10) Pub. No.: US 2007/0223839 A1
(43) Pub. Date: Sep. 27, 2007

(54) Signal noise estimation

(76) Inventors: Pavel Kisilev, Palo Alto, CA (US); Doron Shaked, Palo Alto, CA (US); Mani Fischer, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/388,152

(22) Filed: Mar. 22, 2006

(51) Int. Cl. G06K 9/36

(52) U.S. Cl. 382/286

(57) ABSTRACT

Provided are systems, methods and techniques that estimate the noise level in a signal, such as an image, by ordering windows in the signal based on calculated measures of the variability within each window (i.e., ordering from lowest to highest or, alternatively, from highest to lowest). That order information is then used together with the calculated measures of variability to form an estimate of the noise level. Typically, the techniques of the present invention generate this estimate based on the windows having the lowest or the second-lowest or the several lowest, depending upon the nature of the image, measures of variability.

### BACKGROUND OF THE INVENTION

1. Field of the Invention

The present invention pertains to systems, methods and techniques for estimating the level of noise in a one-, two- or higher-dimensional signal, such as a photograph or other image, video and/or audio signal, etc.

2. Description of the Related Art

Imaging algorithms, such as image enhancement, edge detection, auto-focus, print quality control and others, typically work better if intrinsic image noise level is known. In practice, the noise level is not known in advance, and therefore needs to be estimated from the image data for a given image. Accurate estimation of noise level presents a challenging problem. The noise estimator should not take into account any of the image structure, and therefore most techniques attempt to derive such information from the featureless areas of the image. That is, areas containing features such as edges or texture are excluded from the estimation process. Unfortunately, many natural irregular textures (e.g. grass or leaves at some resolutions) often are statistically indistinguishable from noise, other than in certain acquisition cases such as when using uncorrelated color sensors. As a result, such textures are often misclassified and treated as if they were noisy smooth areas. This results in a significantly higher noise estimate, and in turn, often leads to a poor performance of the image-processing algorithms that utilize such estimates. For example, image enhancement based on such noise estimates typically will result in a more aggressive de-noising and, consequently, a blurry image.

Many image-noise-estimation techniques have been discussed in the image-processing literature. See, for example, S. Olsen, “Noise Variance Estimation in Images: An evaluation”, Graphical Models and Image Process., vol. 55, no. 4, pp. 319-323, 1993. In Harry Voorhees, S. M., “Finding Texture Boundaries in Images,” MIT AI-TR-968, June 1987, an image is first convolved with a Gaussian or Laplacian filter. Then, the histogram of the magnitude of gradient values of the filtered image is calculated. This histogram is said to follow the Rayleigh distribution. The authors argue that, if a large portion of the image consists of uniform intensity with addition of white noise, the edges mainly affect the tail of this histogram. Therefore, the histogram peak location represents a good estimate of the noise level. In a case in which the image contains many textured areas, the authors fit the Rayleigh distribution to a steep rising portion of the histogram, which is supposed to be less affected by texture.

In K. Rank, M. Lendl, and R. Unbehauen, “Estimation of image noise variance”, IEEE Proc. Vis. Image Signal Process., vol. 146, no. 2, pp. 80-84, April 1999, the authors propose a local-variance histogram-based method for noise estimation. First, the noisy image is filtered by a normalized difference operator. Next, a histogram of local variances is computed and fit to a model. Based on this fit, the noise estimate is calculated as a weighted average of the histogram values.

In A. Amer, A. Mitiche, and Eric Dubois, “Reliable and fast structure-oriented video noise estimation”, Proc. IEEE ICIP conf., vol. I, pp. 840-843, 2002, the authors build high-pass operators—a set of 3×3 masks with features such as edge, line, corner, etc. They apply these masks to an image and detect homogeneous areas, wherein the image data reveals no significant correlation with any of the above masks. Sample variances from these homogeneous areas are then used for noise estimation, applying either the median or average operator. Very similar approaches are used in B. Corner, R. Narayanan, and S. Rechenbach, “Noise estimation in remote sensing imagery using data masking”, Int. Jour. Remote Sensing, vol. 24, no. 4, pp. 689-702, 2003, and in P. Tischer, T. Seemann, “Structure Preserving Noise Filtering of Images Using Explicit Local Segmentation”, Proc. ICPR Conf., Vol II, pp. 1610-1612, 1998. In the former, the authors use Laplacian- and gradient-based edge detectors. In the latter, the authors classify image areas into two classes of flat and edge-containing areas, by applying the Sobel edge detector, followed by a thresholding operation.

As is clear from the above brief description of the state-of-art noise estimation algorithms, most of such algorithms preprocess the subject image in order to reduce the influence of image features on the estimate. Nevertheless, examples of maps of presumably featureless image areas shown in these papers reveal remaining structures, such as weak edges or texture. Additional drawbacks of many proposed methods are high computational cost and dependence on multiple, heuristically or empirically chosen parameters. In addition, most of the methods use either explicitly or implicitly the white Gaussian noise assumption, and rely heavily on it.

### BRIEF DESCRIPTION OF THE DRAWINGS

FIG. 1 depicts a representative graph that conceptually shows the distinction between the distribution of pixel variances in featureless blocks of a sample image as compared with the distribution of pixel variances in blocks that include image features.

FIG. 2 is a flow diagram for explaining calculation of image noise according to a first representative embodiment of the present invention.

FIG. 3 is a flow diagram for explaining calculation of image noise according to a second representative embodiment of the present invention.

FIG. 4 is a flow diagram for explaining calculation of image noise according to a third representative embodiment of the present invention.

FIG. 5 is a flow diagram for explaining calculation of image noise according to a fourth representative embodiment of the present invention.

### DESCRIPTION OF THE PREFERRED EMBODIMENT(S)

General Concepts Pertaining to the Invention.

Generally speaking, the areas of an image having the smallest amount of pixel variability will correspond to the featureless areas of the image. As a result, any pixel variability in such areas typically can be attributed to image noise. At the same time, merely selecting regions that have the lowest pixel variabilities generally will not result in a random sampling of the featureless regions of the image.

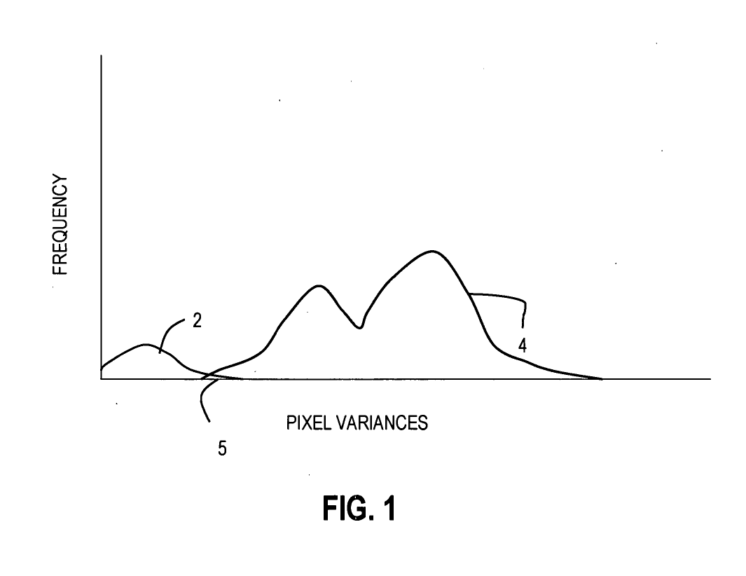

This problem is illustrated with reference to FIG. 1, which shows a representative distribution of pixel variances in an image. More specifically, the graph illustrated in FIG. 1 is intended to show the results that would occur if a sample image were divided into regions that include a plurality of pixels, the pixel variance in each region were calculated, and two histograms of such pixel variances were drawn on the same graph: one for the featureless regions of the image and one for the regions that include image features.

Thus, the distribution in FIG. 1 is divided into two portions: a distribution 2 that corresponds to the featureless (i.e., smooth) regions of the image and a distribution 4 that corresponds to the regions having some image features. Because no features are present in distribution 2, it typically is the case that distribution 2 will represent an approximation of the image noise distribution.

Ideally, therefore, one would like to estimate the image noise only from the featureless regions 2. However, as shown in FIG. 1, it often will be the case that there will be some overlap 5 between the featureless regions 2 and the regions 4 having image features. For example, some regions with no image features but having image noise on the high end of the distribution will have greater pixel variances than other regions that include minimal image features and also happen to have noise levels on the low end of the distribution.

Accordingly, in a representative embodiment of the present invention, the image regions having the very lowest levels of pixel variability (hopefully, having levels that are below the overlap region 5) are used to calculate the level of the image noise. However, because the regions are selected based on this criterion, rather than from a random sampling of the noise distribution (which, as indicated above, is not usually possible), this embodiment of the present invention applies a correction in order to obtain a relatively unbiased estimate of the true level of image noise. As discussed in more detail below, it often is possible to apply a correction that will provide good results across a variety of different images.

Preferably, the term “pixel variability” as used herein is an estimate of the variance or standard deviation of some measurable property or component of the pixel. However, in alternate embodiments different measures of pixel variability instead are used.

The techniques described herein may be applied to any pixel property, such as pixel luminance, brightness, saturation, hue, chromaticity or an individual color component (e.g., red, blue or green). Moreover, in one embodiment such techniques are applied to a single pixel property (using a scalar quantity) or simultaneously to combinations of pixel properties (using vector calculations). In another embodiment, such techniques are applied individually to different pixel properties, and then the results corresponding to the different pixel properties preferably are combined, e.g., by finding the mean or some other linear combination. It is noted that in any case where multiple pixel properties are used, the results obtained often will facilitate identification of regions that appear to be featureless.

Also, for ease of understanding, it is generally assumed throughout this discussion that noise affecting a digital image (one example of a two-dimensional signal) is being estimated. However, it should be understood that the same concepts and principles, and accordingly the same techniques, will apply to one-dimensional signals (e.g., audio signals, seismographic signals, electrocardiogram (EKG) signals, etc.), to other two-dimensional signals, to higher-dimensional signals (e.g., 3-dimensional images) and to signals comprised of multiple synchronized signals (e.g., stereo audio, synchronized video and audio, etc.) in which one would like to estimate additive noise.

Mathematical Background.

The following discussion provides a mathematical basis for certain embodiments of the invention that are discussed in the subsequent sections.

Let us assume that an image is corrupted by an additive white noise with zero mean and variance σ². Namely, it is spatially stationary and has the same power over the luminance range. The assumption of stationarity over the luminance range can be resolved by estimating the noise standard deviation (STD) σ as a function of luminance.

Let an image consist of M smooth (that is, featureless) blocks containing K samples each. In this case, we have M realizations of a noise vector Yₘ whose K elements yₖₘ are identically distributed with an arbitrary distribution y whose unknown variance σ² we want to estimate. The sample variance estimate of σ² based on Yₘ is given by:

$$\begin{matrix}{s}_{m}^{2} = \frac{1}{K - 1} {\sum }_{k = 1}^{K} {( {y}_{k m} - {\overline{y}}_{m} )}^{2} , \\ where & ( Eq . 1 ) \\ {\overline{y}}_{m} = \frac{1}{K} {\sum }_{k = 1}^{K} {Y}_{k m} , & ( Eq . 2 )\end{matrix}$$

is the sample mean.

Let us consider an example where the underlying distribution of y is Gaussian with an unknown variance σ². We can further model the random variable s² of the sample variance. The quantity ξ, related to s² is chi-square distributed with K−1 degrees of freedom:

$$ξ {=}^{Δ} \frac{( K - 1 ) {s}^{2}}{{σ}^{2}} \sim {χ}^{2} ( K - 1 ) . \qquad ( Eq . 3 )$$

This provides the confidence interval for σ²:

$$\frac{( K - 1 ) {s}^{2}}{{χ}_{U}^{2} ( α )} < {σ}^{2} < \frac{( K - 1 ) {s}^{2}}{{χ}_{L}^{2} ( α )} ,$$

where χ_{U}²(α) and χ_{L}²(α) are the upper and the lower-tail values of the chi-square distribution, respectively, given confidence coefficient α (which may be obtained from conventional tables). In other words, sigma is in the interval above with probability larger than or equal to (1−α). For example, suppose that we measured sₘ=10, calculated from K=64 samples, then we have that 7.56<σ²<15.6 with probability 95%. Clearly, such a wide interval is not acceptable for noise estimation. However note that this estimate was obtained from a single measurement sₘ. Fortunately, we can derive a much more accurate estimate of σ, based on several (say, 20) sample variances. This is independent of the distribution of the underlying noise y.

The reason that these results are independent from the underlying noise distribution is based on the Central Limit Theorem (CLT). The CLT implies that distributions of sample means and sample variances of an arbitrarily distributed population are approximately Normal (Gaussian) for sufficiently large sample sizes (K, in our case). For K=64, the distribution is nearly Gaussian. Accordingly, provided that K is sufficiently large, we can assume that the noise distribution across image blocks is Gaussian, even though the distribution at the pixel level may be arbitrary.

The discussion in the preceding paragraph assumes that the noise is uncorrelated from pixel to pixel. This might not be the case where the pixels are very small and/or in other situations where the nature of the noise causes adjacent pixels to be similarly affected. Moreover, it often will not be the case where the image has been JPEG processed or smoothed in some other manner, causing the noise from a single pixel to spread to adjacent pixels. However, the foregoing result generally will hold even in these cases if the block is sufficiently large (e.g., large K) in comparison to the spatial correlation of the noise.

An estimate of σ can be obtained based on several measured values of sₘ. In particular, from (Eq. 1), it follows that

$$\overline{{s}^{2}} {=}^{Δ} E \{ {s}^{2} \} = {σ}^{2} , \qquad ( Eq . 4 )$$

where E{·} denotes the expectation operator. Therefore, one reasonable estimate of σ² given M realizations (in our case, M blocks, each of size K), is the average of sampled variances:

$${\hat{σ}}^{2} = \frac{1}{M} {\sum }_{m = 1}^{M} {s}_{m}^{2} . \qquad ( Eq . 5 )$$

Unfortunately, the number of smooth blocks, M, is not known in practice. Therefore, unless the image contains no features (edges or texture), there will be image blocks that characterize the signal and not the noise. Thus, if we take M to be the number of blocks in the image, the estimate in (Eq. 5) will be heavily influenced by the image features. Nevertheless, as is argued below, the lowest variances generally are unaffected by the image features and, therefore, our aim is to provide an estimate, which is dependent only on the first order statistic, that is, the lowest sample variance, s₍₁₎²=sₘᵢₙ² (or a few lowest variances s₍ₜ₎², for some small set of t.

The intuition behind using the lowest variances is as follows. The variance of s₍ₜ₎ is proportional to 1/K [see (Eq. 5A) and its derivation below], and therefore can assumed to be small. Furthermore, whereas the underlying variance σ² for featureless regions is the noise variance, the underlying variance of the other blocks is larger, namely the noise variance plus some bias due to the local features. Thus, ordering the sample variances of image blocks on a scale, results in a separation of featureless blocks on the low end of the scale and other blocks above them. The addition to the variance due to image features might be very small, and thus we might find very mild texture areas well inside the low part of the sample variance scale. However, the feature content of such blocks is most likely negligible as compared to the noise content, and thus would not influence the noise estimate. Thus, although in some cases there is no way to tell locally, whether a given pattern is noise or texture, global analysis of variances can easily make this distinction.

Let us construct the following quantity:

$$η {=}^{Δ} \frac{{s}^{2} - \overline{{s}^{2}}}{{σ}_{{s}^{2}}} , \qquad ( Eq . 6 )$$

where s̅²̅ as in (Eq. 4), and σₛ_{²}=√Var{s²} is the STD of the distribution of s². It can be shown that

$${σ}_{{s}^{2}} = {σ}^{2} \sqrt{\frac{2}{K - 1}} . \qquad ( Eq . 7 )$$

Clearly, η has a (nearly) standard Normal distribution:
η˜N(0,1)

Note also that, using the definition in (Eq. 6), we have the following relation for order statistics of η:

$${η}_{( t )} = \frac{{s}_{( t )}^{2} - \overline{{s}^{2}}}{{σ}_{{s}^{2}}} , t = 1 , … , M . \qquad ( Eq . 8 )$$

Taking the expectation from both sides of (Eq. 8), and using (Eq. 4) and (Eq. 7), we have

$$E \{ {η}_{( t )} \} = \frac{E \{ {s}_{( t )}^{2} \} - \overline{{s}^{2}}}{{σ}_{{s}^{2}}} = \frac{E \{ {s}_{( t )}^{2} \} - {σ}^{2}}{{σ}^{2} \sqrt{\frac{2}{K - 1}}} . \qquad ( Eq . 9 )$$

Solving (Eq. 9) with respect to σ², we have the following relation:

$${σ}^{2} = \frac{E \{ {s}_{( t )}^{2} \}}{1 + {α}_{t , M} \sqrt{\frac{2}{K - 1}}} , \qquad ( Eq . 10 )$$

where α_{t,M}=E{η₍ₜ₎} is a tabulated value for the mean of the t-th order statistic from a standard normally distributed population, found, e.g., in Borenius, G. (1966) “On the limit distribution of an extreme value in a sample from a normal distribution”, Scandinavian Actuarial Journal, 1965, 1-15.

We can estimate σ² by replacing E{s₍ₜ₎²} with its point estimate, s₍ₜ₎²:

$$\hat{{σ}^{2}} = \frac{{s}_{( t )}^{2}}{1 + {α}_{t , M} \sqrt{\frac{2}{K - 1}}} .$$

This replacement is justified by the fact that s₍ₜ₎ is distributed quite tightly around its mean value [see (Eq. 5A) and its derivation below].

Note that most image-processing algorithms require the estimate of σ and not σ². Therefore, the desired estimate of σ is

$$\hat{σ} = {C}_{t , M , K} \cdot {s}_{( t )} , \\ {C}_{t , M , K} = \frac{1}{{( 1 + {α}_{t , M} \sqrt{\frac{2}{K - 1}} )}^{1 / 2}} . \qquad ( Eq . 11 )$$

The values of C_{t,M,K} can be calculated using the tabulated values of α_{t,M}. Note also that (Eq. 10) suggests an alterative way of calculating C_{t,M,K}, namely Monte-Carlo simulations (using an arbitrary value of σ):

$${C}_{t , M , K} = {( \frac{{σ}^{2}}{E \{ {s}_{( t )}^{2} \}} )}^{1 / 2} .$$

Notice that K and t are design parameters, which may be determined by the application, whereas M is an unknown parameter depending on the given image. As we do not know, we have to assume a value for it. Fortunately, as will be shown below, C_{t,M,K} varies only mildly with M.

It has been found that M=50 is usually a good choice. Other techniques for selecting M include the following. In one embodiment, it is based on the size of the image, e.g., a fixed percentage of the number of blocks in the image. In another, it is estimated by pre-processing the image. One technique for the latter is as follows. We start with a fixed M (e.g., using either of the foregoing techniques), and estimate the noise variance σ², based on it. Then, we calculate a new value of M by counting a number of blocks in an image whose variances satisfy σₖ²<R·\hat{σ}². Here, R is a constant that, in general, depends on the noise distribution, and can be defined based on some statistical test, such as Ftest for homogeneity of variances. For example, for a Gaussian noise R=9. For a noise having a long tail distribution, this number would be greater. Finally, we recompute \hat{σ}² based on a new value of M.

In the following discussion, we analyze statistical properties of the estimator in (Eq. 11), and justify it by showing its good statistical behavior.

We first evaluate the bias and the variance of the estimator in (Eq. 11), for the case where a true value of M is known. The overall error of the estimator consists of these statistical figures, and a deterministic (although unknown) error due to the uncertainty in M. We quantify the effect of the uncertainty in M on the estimator, and show that this effect, while more significant than the estimator bias and variance is minor for most practical purposes. We conclude that the overall performance of the estimator is quite satisfactory for most practical purposes, and can be further enhanced if we have some prior knowledge of M.

An approximate expression for the bias of the estimator is given by (see the discussion below):

$$\begin{matrix}B \{ \hat{σ} \} = \vert E \{ \hat{σ} \} - σ \vert \\ ≅ ≅ σ \cdot \vert \frac{1 + \sqrt{\frac{2}{K - 1}} {α}_{t , M}}{1 + \frac{1}{2} \sqrt{\frac{2}{K - 1}} {α}_{t , M}} \cdot ( - \frac{1}{4} \frac{{β}_{t , M}}{K - 1} ) \vert ,\end{matrix} \qquad ( Eq . 12 )$$

where β_{t,M}=Var{ηₜ} are tabulated values for the variance of the t-th normal order statistics, found in Borenius, supra. It may be shown that β_{t,M} values are bounded from above by 0.3, and thus the ratio

$$\frac{{β}_{t , M}}{K - 1}$$

makes the bias in (Eq. 12) negligible. For example, for K=64 (e.g., square blocks of 8×8 pixels), M=20 (i.e., 20 featureless blocks in the image), t=1 (i.e., using use the lowest sample variance), we have B{\hat{σ}}≦0.001·σ. Therefore, the estimator in (Eq. 11) is virtually unbiased.

Additionally, if instead of the constant C_{t,M,K} we use

$${\tilde{C}}_{t , M , K} = \frac{σ}{E \{ {s}_{( t )} \}} , \qquad ( Eq . 13 )$$

where the expectation is obtained empirically, then the bias is zero up to the accuracy of the empirical calculation.

Further, an approximate expression for the variance of the estimator is given by (see Eq. 5 below):

$$Var \{ \hat{σ} \} ≅ \frac{{β}_{t , M} \cdot {σ}^{2}}{2 \cdot ( K - 1 ) \cdot ( 1 + {α}_{t , M} \sqrt{\frac{2}{K - 1}} )} . \qquad ( Eq . 14 )$$

Although the variance of the estimator is dependent on σ, the following numerical example should hint that the variance of the estimator is very small for most cases of practical interest. Let K=64, M=20, and t=1. Then we have

$$\frac{Var \{ \hat{σ} \}}{{σ}^{2}} \leq 0.0032 .$$

Note also, that the variance of the estimator drops dramatically with increasing K. In particular, for K=256, and the same setting as above, we have

$$\frac{Var \{ \hat{σ} \}}{{σ}^{2}} \leq 0.00064 .$$

Further, if for a given image a true value of M, namely M₀, is not known, and some fixed M* is used instead, then there is an additional, deterministic bias, Δ\hat{σ}(M*,M₀), introduced into the estimate due to the uncertainty in M. Therefore, the overall error of the estimator in (Eq. 11) is a sum of two components, the statistical error of the estimator, given a true value of M, and the deterministic error, caused by the uncertainty in M. In particular, the mean-squared error in this case is:

$$\begin{matrix}{ɛ}^{2} = E \{ {[ ( \hat{σ} + Δ \hat{σ} ( {M}^{*} , {M}_{0} ) ) - σ ]}^{2} \} \\ = E \{ {[ \hat{σ} - σ ]}^{2} \} + Δ {\hat{σ}}^{2} ( {M}^{*} , {M}_{0} ) + \\ 2 \cdot Δ \hat{σ} ( {M}^{*} , {M}_{0} ) \cdot E \{ \hat{σ} - σ \} .\end{matrix} \qquad ( Eq . 15 )$$

It is easy to show that the first term in (Eq. 15) is:
E{[\hat{σ}−σ]²}=Var{\hat{σ}}+B{\hat{σ}}².

Further, the second term in (Eq. 15), namely the deterministic error, can be shown to be

$$Δ \hat{σ} ( {M}^{*} , {M}_{0} ) = \hat{σ} ( {M}_{0} ) \cdot \frac{( {α}_{t , {M}^{*}} - {α}_{t , {M}_{0}} ) \cdot \sqrt{\frac{1}{2 ( K - 1 )}}}{1 + {α}_{t , {M}_{0}} \cdot \sqrt{\frac{1}{2 ( K - 1 )}}} . \qquad ( Eq . 16 )$$

For example, for K=64, t=1, and M varying from 20 to 100 (the maximum M value for which α_{K,M} is tabulated in Borenius, supra), we have from the table: α_{1,20}=−1.867 and α_{1,100}=−2.5, and Δ\hat{σ}(20,100)/\hat{σ}=−0.063, which is a reasonably small relative variation. For K=256, the relative variation is smaller: Δ\hat{σ}(20,100)/\hat{σ}=−0.029. If we want to get Δ\hat{σ} values for a larger variation of M, we generally cannot use the tables, and have to resort to Monte Carlo simulations. There we have that Δ\hat{σ}(20,2000)/\hat{σ}≈−0.07.

Finally, the third term in (Eq. 15) is negligible, since as shown above, E{\hat{σ}−σ} is much smaller than Δ\hat{σ}(M*,M₀).

We conclude that the inaccuracy of the estimator in (Eq. 11) is mainly due to the unknown M, and is on the order of 7% even for very high uncertainty.

To keep a bound on the error of the estimator due to the uncertainty in parameter M, we can change K to keep the total number of blocks in the image nearly constant over a wide variety of image sizes (resolutions). That is, by keeping the ratio L/K constant, where L is the overall number of pixels in the image. This will have two beneficial effects. Primarily, the number of blocks in the image is bounded, and thus also M is bounded. Further, as the image size (or L) increases, so does K, and the error terms in (Eq. 12), (Eq. 14), and (Eq. 16) decrease.

In the following discussion, we provide two different modifications of the noise estimation method, which may be particularly applicable when treating the cases of artificial noise types, such as JPEG noise. We first discuss noise estimation based on higher-order statistics.

In natural images, artificial noise types, such as JPEG, often inevitably are added to the image. As a result, the 1^{st} order statistic, such as s₍₁₎=sₘᵢₙ is not quite reliable. For example, if an image was previously JPEG compressed, or smoothed (e.g., de-noised) by some application, it is very likely that some of the blocks have very low, or even zero variance. One way to address this problem is to estimate the noise variance by utilizing up to T-order statistics instead of just sₘᵢₙ. Preferably, we average the T lowest sample variances:

$${\hat{σ}}_{A} = {C}_{T , M , K}^{A} \frac{1}{T} {\sum }_{t = 1}^{T} {s}_{( t )} , \qquad ( Eq . 17 )$$

where superscript A emphasizes the averaging of lower order statistics, and C_{T,M,K}^{A} can be derived in a similar way to the respective constant in the estimator of (Eq. 11) above, while using tables for the mean and the variance of average of T largest normal order statistics taken from Joshi, P. C. and Balakrishnan, N. (1981), “An identity for the moments of normal order statistics with applications”, Scandinavian Actuarial Journal, 1981, 203-213. Alternatively, \tilde{C}_{T,M,K}^{A} can be found empirically, much like in (Eq. 13).

It has been found empirically that a good choice for T is 30. In a more general setting, T can be chosen adaptively, according to a given image statistics. In particular, if there are enough smooth areas in the image, then T can be large, since there are many featureless areas. In contrast, if there were few smooth areas detected (e.g., by using a preprocessing technique), then we would rather use a small number T of blocks with lowest variances, or, in an extreme case, only one block with the minimum variance as in (Eq. 11). As noted in the previous section, parameter M can be chosen arbitrarily to be e.g. M=50. Variations due to uncertainty in M induce a relatively minor bias.

In the following discussion, we provide a technique that estimates the noise level while performing a classification of image areas according to their levels of pixel variability. This classification often can be used to separate featureless from texture areas, as well as to separate over-smoothed areas (due to, e.g., JPEG compression).

Levine's test is a powerful test on homogeneity of variances. See, e.g., A. Edwards, “Multiple Regression and the Analysis of Variance and Covariance”, Freeman and Co., New York, 1985. In certain embodiments of the invention, it is used to help us cluster blocks that share the same intrinsic variance. Thus we often are able to separate over-smoothed blocks on the lower end of the scale, from plain featureless blocks (the statistical source for noise estimation) right above them, and those from texture or edge blocks as we go up on the variance scale.

Let us define a new quantity:
Zₖₘ=|Yₖₘ− Y̅ₘ|,
where Y̅ₘ is the sample mean as defined in (Eq. 2), or alternatively, sample median. The Levine test statistic is defined as

$$l = \frac{K \frac{1}{M - 1} {\sum }_{m = 1}^{M} {( {\overline{z}}_{m} - \frac{1}{M} {\sum }_{m = 1}^{M} {\overline{z}}_{m} )}^{2}}{\frac{1}{M} {\sum }_{m = 1}^{M} \frac{1}{K - 1} {\sum }_{k = 1}^{K} {( {z}_{k m} - {\overline{z}}_{m} )}^{2}} . \qquad ( Eq . 18 )$$

Note that the numerator in (Eq. 18) is K times the variance among M group sample means for variable z, and the denominator is the average of M “within-group” variances for variable z.

If l>C_{α,M-1,M(K-1)}^{F}, where C_{α,M-1,M(K-1)}^{F} is taken from the F-distribution table, and α is the critical value for this distribution (that is, the desired accuracy), then, with probability greater than α, the M groups (that is, realizations of vector Yₘ) contain samples yₖₘ drawn from distributions with different variances.

The intuition behind this test is as follows. The Central Limit Theorem implies that the variance of the sample mean is the population variance divided by sample size. In our case, for arbitrarily distributed z˜D(μ_{z},σ_{z}²) the distribution of sample means for sufficiently large K is z̅˜N(μ_{z},σ_{z}²/K). Levine's test utilizes this fact by comparing two variance estimates: the average of M sample variances (the denominator), and the variance among group means (the numerator) multiplied by K. If all zₖₘ are drawn from the same distribution, then the above two estimates are nearly equal, and the l-ratio in (Eq. 18) is close to 1. Otherwise, if the l-ratio is not close to 1, this indicates that some of the Zₖₘ and, therefore, the yₖₘ are drawn from different distributions.

The following procedure based on Levine's test can be used for both noise estimation and for classification purposes (one might be interested in classifying image blocks into classes of: (I) smoothed areas, (II) featureless, possibly noisy areas, (III) textured areas, and (IV) edges):
1. Calculate sample variance for each image block (each block contains K samples).
2. Form the test group from the block with the lowest sample variance.
3. Calculate Levine's statistic, l, for the test group.
4. IF l<C_{α,M-1,M(K-1)},
   THEN add the block with the next lowest variance to the test group; and
      go to 3.
   ELSE go to 5.
5. Calculate the variance estimate for the class by averaging the sample variances of the test group.
6. IF another class is required,
   THEN exclude the variances from the previous class and go to 2.
   ELSE STOP

Note also that other quantities can be used instead of z. For example, a directionally sensitive quantity based on “directionally coherent” differences can be used instead of z in Levine's test. In addition, quantities, which are not sensitive to linear (or higher order) change in a luminance profile, can be utilized, for example
z_{k,m}=|y_{k,m}+Y_{-k,m}−2 Y̅ₘ|,
where y_{k,m}, y_{-k,m} are values of pixels situated symmetrically with respect to the central pixel of a block.

Once the various classes have been separated by the algorithm, the noise estimate preferably is the average sample variance of the first class or, alternatively, if the image source is a JPEG file, the noise estimate preferably is the average sample variance of the second class.

We now discuss certain concepts related to order statistics.

Let X₁, . . . , Xₙ be random variables with realizations in R. Given an outcome w, order xᵢ=Xᵢ(w) in non-decreasing order so that
x₍₁₎≦x₍₂₎≦ . . . ≦x₍ₙ₎,
x₍₁₎=min(x₁, . . . , xₙ),
x₍ₙ₎=max(x₁, . . . , xₙ).

Then each X₍ᵢ₎, such that X₍ᵢ₎(w)=x₍ᵢ₎, is a random variable. Statistics defined by X₍₁₎, . . . , X₍ₙ₎ are called order statistics of X₁, . . . , Xₙ. If all the orderings are strict, then X₍₁₎, . . . , X₍ₙ₎ are the order statistics of X₁, . . . , Xₙ. Furthermore, each X₍ᵢ₎ is called the i-th order statistic of X₁, . . . , Xₙ.

Note, that for simplicity of presentation, we use a single notation x₍ᵢ₎ for both, order statistic random variable, and its outcome. Note also, that we use x for random variable, and xᵢ for its outcome.

The absolute bias of the estimator in (Eq. 11) is
B{\hat{σ}}=|E{\hat{σ}}−σ|=|C_{t,M,K}·E{sₜ}−σ|.

By substituting (Eq. 4) and (Eq. 7) into (Eq. 8) we have

$${s}_{( t )} = {σ ( 1 + \sqrt{\frac{2}{K - 1}} {η}_{( t )} )}^{1 / 2} . \qquad ( Eq . 1 A )$$

Since

$$\vert \sqrt{\frac{2}{K - 1}} {η}_{t} \vert < 1$$

holds for large K's, with probability close to 1, we can use the Taylor series expansion for the square root function:

$${( 1 + x )}^{1 / 2} = 1 + \frac{1}{2} x - \frac{1}{8} {x}^{2} + \frac{1}{16} {x}^{3} - … \qquad ( Eq . 2 A )$$

Then, using (Eq. 1A) and (Eq. 2A), and taking the expectation, we have:

$$\begin{matrix}E \{ {s}_{( t )} \} = E \{ {σ ( 1 + \sqrt{\frac{2}{K - 1}} {η}_{( t )} )}^{1 / 2} \} \\ = σ ( \begin{matrix}\begin{matrix}1 + \frac{1}{2} \sqrt{\frac{2}{K - 1}} E \{ {η}_{( t )} \} - \\ \frac{1}{8} \frac{2}{K - 1} E \{ {η}_{( t )}^{2} \} +\end{matrix} \\ \frac{1}{16} {( \frac{2}{K - 1} )}^{3 / 2} E \{ {η}_{( t )}^{3} \} - … \end{matrix} )\end{matrix} \qquad ( Eq . 3 A )$$

Further, using the definition of C_{T,M,K} from (Eq. 11), and using the Taylor series expansion for its denominator, we have

$$\begin{matrix}B \{ \hat{σ} \} = \vert {C}_{t , M , K} \cdot E \{ {s}_{t} \} - σ \vert \\ = σ \cdot \vert \frac{( \begin{matrix}1 + \frac{1}{2} \sqrt{\frac{2}{K - 1}} {α}_{t , M} - \frac{1}{4} \frac{{α}_{t , M}^{2} + {β}_{t , M}}{K - 1} + \\ \frac{1}{16} {( \frac{2}{K - 1} )}^{3 / 2} E \{ {η}_{( t )}^{3} \} - …\end{matrix} )}{( \begin{matrix}1 + \frac{1}{2} \sqrt{\frac{2}{K - 1}} {α}_{t , M} - \frac{1}{4} \frac{{α}_{t , M}^{2}}{K - 1} + \\ \frac{1}{16} {( \frac{2}{K - 1} )}^{3 / 2} {α}_{t , M}^{3} - …\end{matrix} )} - 1 \vert \\ = σ \cdot \vert \frac{( \begin{matrix}- \frac{1}{4} \frac{{β}_{t , M}}{K - 1} + \\ \frac{1}{16} {( \frac{2}{K - 1} )}^{3 / 2} ( E \{ {η}_{( t )}^{3} \} - {α}_{t , M}^{3} ) - …\end{matrix} )}{{( 1 + {α}_{t , M} \sqrt{\frac{2}{K - 1}} )}^{1 / 2}} \vert ,\end{matrix}$$

where β_{t,M}=Var{η_{t,M}} are tabulated values for the variance of the t-th normal order statistics, found in [9], and are bounded above by 0.3.

Because of the fast decay of the terms in the Taylor series expansion (due to large K), we can approximate the above expression by

$$B \{ \hat{σ} \} ≅ σ \cdot \vert \frac{1}{{( 1 + {α}_{t , M} \sqrt{\frac{2}{K - 1}} )}^{1 / 2}} \cdot ( - \frac{1}{4} \frac{{β}_{t , M}}{K - 1} ) \vert . \qquad ( Eq . 4 A )$$

The variance of the estimator is:

$$\begin{matrix}Var \{ \hat{σ} \} = {C}_{t , M , K}^{2} \cdot Var \{ {s}_{t} \} \\ = {C}_{t , M , K}^{2} \cdot {σ}^{2} \cdot Var \{ ( \begin{matrix}1 + \frac{1}{2} \sqrt{\frac{2}{K - 1}} {η}_{( t )} - \frac{1}{8} \frac{2}{K - 1} {η}_{( t )}^{2} + \\ \frac{1}{16} {( \frac{2}{K - 1} )}^{3 / 2} {η}_{( t )}^{3} - …\end{matrix} ) \}\end{matrix}$$

Again, using the fast decay of the series, and leaving the first two terms, we have an approximate expression for the variance of the estimator:

$$Var \{ \hat{σ} \} ≅ \frac{{β}_{t , M} \cdot {σ}^{2}}{2 \cdot ( K - 1 ) \cdot ( 1 + {α}_{t , M} \sqrt{\frac{2}{K - 1}} )} . \qquad ( Eq . 5 A )$$

We now discuss embodiments of the present invention that utilize the concepts discussed above. In the specific examples described below, it generally is assumed that the underlying signal is an image signal. However, the techniques and considerations set forth in the following discussion also apply in a straightforward manner to any other type of input signal. Thus, each reference below to an image or an image signal usually can be replaced with a generic reference to a signal. Similarly, each reference to a pixel usually can be replaced with a generic reference to a data sample.

### First Representative Embodiment

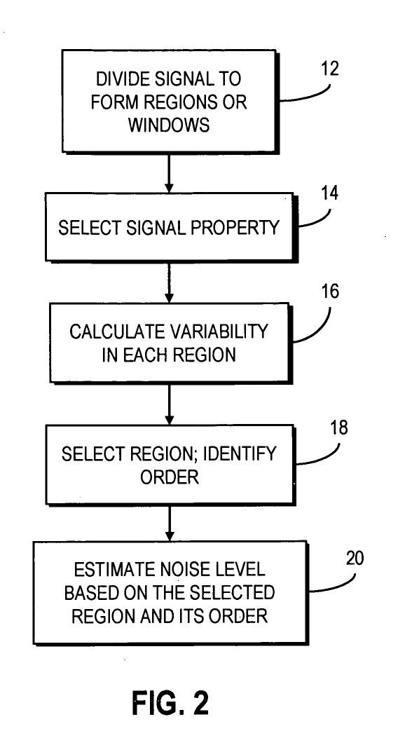

FIG. 2 is a flow diagram for explaining calculation of noise in an image signal, according to a first representative embodiment of the present invention.

Initially, in step 12 an input signal (an image frame in the present example) is divided so as to form a plurality of windows or regions. Preferably, as with many other image-processing techniques, the regions are contiguous square blocks of pixels, e.g., 8×8 or 16×16 pixels, that together covered the entire image. However, in alternate sub-embodiments other types of windows or regions instead are used.

For example, the windows or regions need not collectively cover the entire image (or other type of input signal). Instead, in such alternate sub-embodiments the regions ultimately provided by this step 12 exclude areas of the image that are known (e.g., as a result of a pre-processing technique) to contain image features. Also, in certain embodiments of the invention the windows or regions into which the image is divided are overlapping while in other embodiments all such windows or regions are strictly non-overlapping.

As indicated above, each region preferably has at least 64 pixels (e.g., 8×8). For images that have been JPEG processed or otherwise smoothed or low-pass filtered, a larger minimum size (e.g., 16×16) preferably is used. Subject to that constraint, in certain sub-embodiments it is preferable to start with a constant number of blocks covering the entire image (although, as noted above, some might be discarded following pre-processing), so that the number of pixels in each block increases for larger or higher-resolution images.

In step 14, a pixel property (or, more generally, a signal property) is selected that will form the basis of the analysis in the rest of this process. When the image is black and white, the pixel property preferably is a binary quantity indicating whether the pixel is black or white. When the image is grayscale, the pixel property preferably is the grayscale level. When the image is color, each pixel generally can be described by a combination of three color components, with the specific three being dependent upon the particular color system that is chosen. Accordingly, for color images it generally is preferable to select one of the color components for processing (or to generate a new measure that is based on the three color components, e.g., generating an intensity measure where the image is represented by red, green and blue color components). However, in certain sub-embodiments, two three or more color components are processed simultaneously, e.g., by representing such multiple components as a vector.

In the discussion below, consistent with the discussion of the mathematical background above, it is assumed that a single scalar quantity is being analyzed. In any event, the value of the selected property or properties will be referred to in the discussion below as the “signal value”.

In step 16, a measure of variability in the signal value is calculated for each region identified in step 12. Preferably, this measure is calculated as the sample variance of the signal values within the subject region, e.g., in accordance with (Eq. 1) above. However, in alternate embodiments any other measure of the variation among the signal values within the region is used.

In step 18, one of the regions is selected and its order is identified. In the present embodiment of the invention, the region is selected according to a single criterion: the one having the lowest magnitude of signal value variability. Accordingly, the region is selected at the same time that its order is identified. In this way, we can generally be fairly certain that the selected region does not include any image features. However, in alternate sub-embodiments a different region is selected, based on any other (or any additional) criteria.

In step 20, the image noise is calculated based on the signal value variability and the order of the selected region. As indicated above, this step preferably is performed by adjusting the pixel variability for the selected region to reflect that it generally will not be a random sample of the featureless regions. More preferably, the signal value variability for the selected region is multiplied by a constant that is based on: the order of the selected region (t which preferably is 1 in this embodiment), an assumed number (M) of featureless blocks in the image (or other input signal), and the number of pixels (or, more generally, data samples) in the selected region (K), i.e., C_{t,M,K}. Several different ways are identified above to determine C_{t,M,K}, by assuming a Gaussian distribution of pixel variability measure, which is appropriate if the selected region is large enough. Alternatively, a different technique preferably is used if a different distribution is assumed.

The actual number of featureless blocks (or windows), M, generally will not be known accurately. However, by performing a certain amount of pre-processing, an estimate can be obtained. Even where no image-specific (or, more generally, signal-specific) information is obtained, it typically will be acceptable to use a default number, e.g., of M=50. In any event, as shown above, the precise number that is used for M typically will not unduly affect the results.

### Second Representative Embodiment

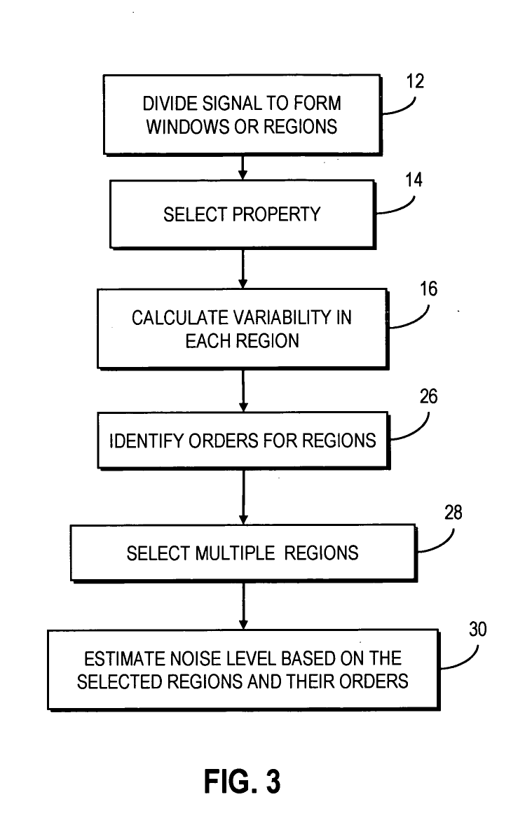

FIG. 3 is a flow diagram for explaining calculation of noise in an image signal, according to a second representative embodiment of the present invention. Steps 12, 14 and 16 in the technique of FIG. 3, as well as the considerations pertaining to such steps, are identical to the identically numbered steps discussed above.

In step 26, orders are assigned to at least some of the regions based on the magnitude of the variability measures that were calculated in step 16. In one preferred sub-embodiment, all of the regions are sorted based on the magnitudes of their signal value variabilities, either from highest to lowest or from lowest to highest. In an alternate sub-embodiment, only the N regions having the lowest signal value variabilities are identified, where N is a fixed number (e.g., 30) or is selected based on image properties, such as a percentage of the expected number of featureless regions or windows.

In step 28, several of the regions are selected. In the preferred embodiment, the regions having the lowest signal value variabilities (e.g., the N lowest) are selected. In more particularized sub-embodiments, various additional considerations are utilized when selecting the regions in this step. For example, in one sub-embodiment of the invention, the regions having the N lowest signal value variabilities initially are selected and then, using a statistical test to identify outliers, some are discarded. Such outliers often are an important factor, e.g., in JPEG-processed or other smoothed images (or other low-pass filtering), where the filtering results in a significant number of pixels that have a noise level quantized down to zero.

In step 30, the image noise level is estimated based on the pixel variabilities and the identified orders for the selected regions. Preferably, this estimation is performed by combining the pixel variabilities for the selected regions and applying an adjustment (which is based on the orders of the selected regions) to account for the fact that the selected regions generally will not be a random sampling of the featureless regions. More preferably, the estimate is formed as set forth in (Eq. 17) above. In one sub-embodiment, the adjustment is applied prior to combining the individual pixel variabilities and in another it is applied after such combination.

It is noted that the combination of pixel variabilities from multiple regions often can be particularly helpful in identifying the noise level for JPEG-processed images and/or images or other types of signals that have been smoothed in some other way. However, the above technique also may be applied advantageously to other types of images (or, more generally, other types of signals) as well.

### Third Representative Embodiment

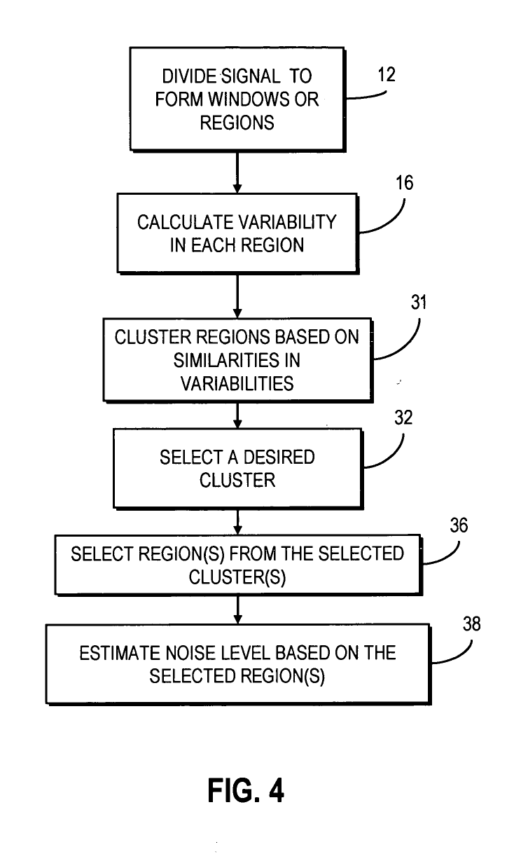

FIG. 4 is a flow diagram for explaining calculation of image noise according to a third representative embodiment of the present invention, in which clustering of regions is used. Steps 12 and 14 in the technique of FIG. 4, as well as the considerations pertaining to such steps, are identical to the identically numbered steps already discussed above.

In step 31, the various regions are grouped into distinct clusters based on similarities in their signal value variabilities (i.e., variances, in the current embodiment). Preferably, as discussed above, Levine's test is used for clustering the regions.

In step 32, a desired cluster is (or desired clusters are) selected. Preferably, if the subject image is not believed to have been JPEG-processed or otherwise smoothed (or low-pass filtered), the cluster having the lowest signal value variabilities is selected; otherwise, the cluster having the second-lowest, or the clusters having the several lowest signal value variabilities are selected.

In step 36, regions are selected from the cluster selected in step 32. Preferably, all of the regions in the selected cluster are selected in this step. However, in other sub-embodiments only a subset of the regions in the selected cluster are selected, e.g., by discarding regions that are suspected to contain image features or that are known to be outliers.

Finally, in step 38 the image's noise level is estimated based on the selected regions. Preferably, this step is performed by taking the mean pixel variability across all of the selected regions and applying an order-based adjustment (as discussed above) to account for the fact that the selected regions were not randomly chosen from the featureless regions.

### Fourth Representative Embodiment

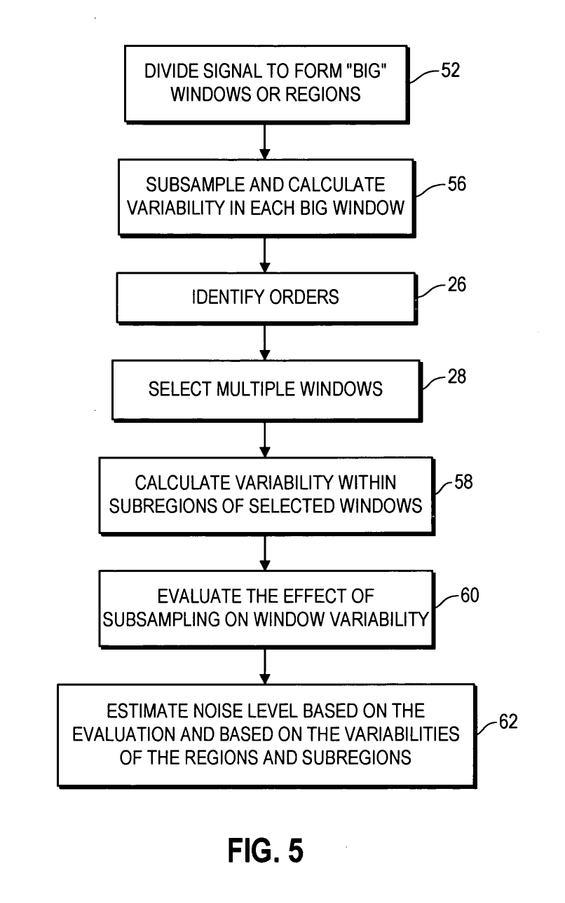

FIG. 5 is a flow diagram for explaining calculation of image noise according to a fourth representative embodiment of the present invention, in which variabilities are calculated at different resolutions and a comparison between the results is used to steer the processing. This technique can be particularly useful in providing reliable noise estimate in ‘difficult data’ cases. Examples of such ‘difficult data’ are: (1) images compressed at very high compression ratio; and (2) images containing no smooth areas (that is texture-only images). If it is known whether or not either of these conditions is present in a given signal, then a decision whether to apply the present technique can be made (e.g., apply the present technique only if one of such conditions is known to exist). Otherwise, if there is some uncertainty about one or both of such conditions, then the present technique preferably is applied as the default.

Initially, in step 52 the signal is divided into “big” windows or regions. Generally speaking, the idea that is for each such “big” window to encompass multiple smaller subregions. For example when processing an image each big window might encompass a 24×24 pixel window that includes a 3×3 block of 8×8 pixel subregions.

In step 56, each window is subsampled, preferably in accordance with the number of subregions within it. In the previous example, each window preferably would be subsampled by a factor of 3, thereby resulting in 8×8 samples in each big window. Then, a measure of the window's variability is calculated, e.g., in a manner similar to that described above in step 16.

In steps 26 and 28, the windows are ordered and a plurality of them are selected. These steps, together with the considerations pertaining to such steps, are identical to the identically numbered steps already discussed above. Accordingly, such details are not repeated here.

Next, in step 58 variabilities are calculated for the subregions of the selected windows. Once again, these variabilities are calculated, e.g., in a manner similar to that described above in step 16.

In step 60, the measures of variability for the subregions are compared to the measures of variability for the selected windows that include such subregions. One technique for doing so is to compare the window variability to the mean (or other statistic, e.g. median) of the variabilities for the subregions within them, e.g., by first calculating a measure q as follows:

$$\overline{s} = \frac{1}{K} {\sum }_{k = 1}^{K} {s}_{k} ,$$

K=9 for subsamp=3
sₖ is the variability of the full-resolution subregion k found in the corresponding big window
Then, the comparison measure q is:

$$q = \frac{1}{N} {\sum }_{n = 1}^{N} \frac{{\overline{s}}_{n}}{{\tilde{s}}_{n}} = \frac{1}{N} {\sum }_{n = 1}^{N} \frac{1}{K} {\sum }_{k}^{K} \frac{{s}_{n , k}}{{\tilde{s}}_{n}}$$

N is the number of sub-sampled big windows with lowest variability
\tilde{s} is the variability of the subsampled big window

Finally, in step 62 the noise level is estimated based on the comparison. In one representative embodiment pertaining to the previous example, q is used to control the processing as follows.

If the measure of difference q (or any other comparison measure used) is significant, this indicates a ‘problem’. Note that q is an average of, roughly, N*KF-distributed variables. Note also that if sample variances Sₖ 's and \tilde{s}ₙ's are from the same distribution, then |q−1|<Th, where Th approaches 0 for N□K→∞. The threshold Th preferably is inversely related (e.g., inversely proportional) to N*K and preferably is calculated from the F-distribution table. For example, in one embodiment for N=30 and K=9, Th=0.15. Therefore, if |q−1|>Th, this indicates a ‘problem’. In fact, an exact value of the threshold Th is not crucial, because in the case of a high JPEG compression or high texture content |q−1|>>Th.

If a ‘problem’ is detected, the process preferably proceeds as follows. For each one of N sub-sampled windows:

(1) if several (e.g., 2 or more) out of K full-resolution subregions have very low (e.g., lower than 0.5) variability, this indicates high JPEG compression, and the subsampled window variability is used as a measure of variability of the subsampled window;

(2) if there are few (e.g., less than 2) very-low-variability subregions in the set of K full resolution subregions, this indicates texture content in the big window, in which case a ‘texture warning’ preferably is issued and, unless condition (3) below also is true, the smallest of the K variabilities is used as a measure of variability of the big window;

(3) If many, e.g. half, out of N Windows reveal texture content, as indicated in condition (2) above, then the noise-estimation routine preferably is performed from the beginning on the full-resolution image (e.g., as described above in connection with FIG. 3).

It should be noted that the present technique is applicable to any type of signal and any type of window, although generally described above in the context of a particular type of a window, namely, an image block.

Testing for Outliers

In any of the foregoing embodiments (whether involving full-resolution or subsampled data), it often will be desirable to test for and eliminate any outliers. One technique for doing so is to first test several (e.g., 5 out of 30) lowest variabilities for presence of outliers, using for example the F-test. If they are found to be outliers, they are removed from the set of 30. Next, the regions/subregions (generically referred to as “blocks”) having the highest variabilities in the set are tested for the presence of outliers (using, e.g., the F-test). If they are found to be outliers, they are removed from the set of 30.

The noise estimate is then generated based on the set of remaining T variabilities, e.g., in accordance with Eq. 17 above. In a more general case, the noise STD estimate is \hat{σ}=C_{T,K,w}·w({sₜ}ₜ₌₁^{T}), where w is some statistic, e.g. a weighted average, of a set sₜ, t=1, . . . , T of the block variabily measures, and C_{T,K} is a constant dependent on the block size K, on T, and on a choice of w.

Extension to Other Noise-Estimation Problems

As mentioned previously, the specific embodiments described above pertain to estimation of noise in an image frame. However, as also pointed out above, the techniques and concepts herein may be applied to noise estimation with respect to any signal for which is expected that there will be an adequate number of featureless windows or regions, i.e., windows in which the relevant underlying signal is 0 or is some other default or bias value for non-informational windows. Thus, for example, the featureless windows or regions for an audio signal will be those time periods during which no actual sound was captured (i.e., so that any signal that is present is due solely to noise and potentially a constant bias).

More generally, the featureless windows or regions typically will correspond to those windows for which there was either no sensor input or no variation in the sensor input. It is noted that with respect to certain signals, it often will be desirable to perform a certain amount of pre-processing to obtain the relevant information and, accordingly, whether the relevant underlying signal actually had any variation. For instance, with respect to a Doppler sensor, it often will be desirable to first perform at least a frequency transformation. Then, any time periods that correspond to a constant frequency signal will be considered as the “featureless” windows.

With respect to signals other than two-dimensional images, the windows or regions preferably are defined with respect to the same dimensions as the signal itself. Otherwise, the techniques and concepts above apply in a straightforward manner to such other types of signals.

System Environment.

Generally speaking, nearly all of the methods and techniques described herein can be practiced with the use of a general-purpose computer system. Such a computer typically will include, for example, at least some of the following components interconnected with each other, e.g., via a common bus: one or more central processing units (CPUs), read-only memory (ROM), random access memory (RAM), input/output software and/or circuitry for interfacing with other devices and for connecting to one or more networks (which in turn, in many embodiments of the invention, connect to the Internet or to any other networks), a display (such as a cathode ray tube display, a liquid crystal display, an organic light-emitting display, a polymeric light-emitting display or any other thin-film display), other output devices (such as one or more speakers, a headphone set and/or a printer), one or more input devices (such as a mouse, touchpad, tablet, touch-sensitive display or other pointing device; a keyboard, a microphone and/or a scanner), a mass storage unit (such as a hard disk drive), a real-time clock, a removable storage read/write device (such as for reading from and/or writing to RAM, a magnetic disk, a magnetic tape, an opto-magnetic disk, an optical disk, or the like), and a modem (which also preferably connect to the Internet or to any other computer network via a dial-up connection). In operation, the process steps to implement the above methods, to the extent performed by such a general-purpose computer, typically initially will be stored in mass storage (e.g., the hard disk), are downloaded into RAM and then executed by the CPU out of RAM.

Suitable computers for use in implementing the present invention may be obtained from various vendors. Various types of computers, however, may be used depending upon the size and complexity of the tasks. Suitable computers include mainframe computers, multiprocessor computers, workstations, personal computers, and even smaller computers such as PDAs, wireless telephones or any other appliance or device, whether stand-alone, hard-wired into a network or wirelessly connected to a network. In addition, although a general-purpose computer system has been described above, in alternate embodiments a special-purpose computer instead (or in addition) is used. In particular, any of the functionality described above can be implemented in software, hardware, firmware or any combination of these, with the particular implementation being selected based on known engineering tradeoffs. In this regard, it is noted that the functionality described above primarily is implemented through fixed logical steps and therefore can be accomplished through programming (e.g., software or firmware), an appropriate arrangement of logic components (hardware) or any combination of the two, as is well-known in the art.

It should be understood that the present invention also relates to machine-readable media on which are stored program instructions for performing the methods of this invention. Such media include, by way of example, magnetic disks, magnetic tape, optically readable media such as CD ROMs and DVD ROMs, semiconductor memory such as PCMCIA cards, etc. In each case, the medium may take the form of a portable item such as a small disk, diskette, cassette, etc., or it may take the form of a relatively larger or immobile item such as a hard disk drive, ROM or RAM provided in a computer.

The foregoing description primarily emphasizes electronic computers. However, it should be understood that any other type of computer instead may be used, such as a computer utilizing any combination of electronic, optical, biological and/or chemical processing.

Additional Considerations.

In any of the foregoing embodiments, it should be noted that variance of a block, or the median absolute deviation of the block samples from the block mean, or others statistics can be used as a measure of block variability.

Also, any of the foregoing techniques can be modified so as to include comparing the median and/or mean absolute deviation of the block samples from the block mean in order to provide an additional indication of texture presence in the block. If the ratio of the median over the mean is significantly bigger than, e.g., 1.3, then the tested block, most likely, contains texture. In representative embodiments of the invention, such a test is used in conjunction with the test described in the section above titled “Fourth Representative Embodiment”.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A method of estimating noise in a signal, comprising:
(a) dividing a signal so as to form a plurality of windows, each of said windows comprising a plurality of data samples;
(b) calculating a measure of variability in each of the windows;
(c) selecting one of the windows;
(d) identifying an order for the selected window, the order corresponding to a rank when comparing the measure of variability in said selected window to the measure of variability in others of the plurality of windows; and
(e) estimating a level of noise in the signal based on the order and the calculated measure of variability for the selected window.

2. A method according to claim 1, wherein said estimating step (e) comprises applying a correction to the calculated measure of variability for the selected window in order to estimate a result that would have been obtained if the selected window had been obtained from a random selection of featureless windows in the signal.

3. A method according to claim 2, wherein the applied correction is based on an assumption that the variability across the featureless windows has a Gaussian distribution.

4. A method according to claim 2, wherein the correction is applied by multiplying the calculated measure of variability for the selected window by a constant value selected from a lookup table.

5. A method according to claim 1, wherein the signal comprises an image frame.

6. A method according to claim 5, wherein said estimating step (e) comprises applying a correction to the calculated measure of variability for the selected window that depends on the size of the window and that depends on at least one of the size or intrinsic resolution of the image frame.

7. A method according to claim 1, wherein the selection in step (c) identifies the window having a lowest measure of variability.

8. A method according to claim 1, further comprising a step of determining the order for at least a subset of the plurality of windows prior to the selection in step (c), and wherein the selection in step (c) is based on a comparison of said orders.

9. A method according to claim 1, further comprising steps of identifying subregions of the window selected in step (c), calculating a measure of variability in each of the subregions, and comparing the measures of variability for the subregions to the measure of variability for the selected window, and wherein the level of noise in the signal also is based on said comparison.

10. A method for estimating noise in a signal, comprising:
(a) dividing a signal so as to form a first plurality of windows, each of said windows comprising a plurality of data samples;
(b) calculating a measure of variability in each of the windows;
(c) identifying an order for each of a second plurality of the windows, the second plurality being at least a subset of the first plurality, and the order corresponding to a rank when comparing the measure of variability in said each window to the measure of variability in others of the first plurality of windows;
(d) selecting a third plurality of the windows based on the orders assigned to the windows in step (c), the third plurality being at least a subset of the second plurality; and
(e) estimating a level of noise in the signal by using the calculated measure of variability for each of the selected windows only.

11. A method according to claim 10, wherein said estimating step (e) comprises:
(i) combining the calculated measures of variability for all of the selected windows only; and
(ii) applying a correction in order to estimate a result that would have been obtained if a random selection of featureless windows had been performed in step (d).

12. A method according to claim 11, wherein the correction in step (e)(ii) is based on an assumption that the variability across the selected windows has a Gaussian distribution.

13. A method according to claim 10, wherein said estimating step (e) comprises:
(i) combining the calculated measures of variability for all of the selected windows only, thereby providing a combined variability measure; and
(ii) correcting the combined variability measure in order to estimate a result that would have been obtained if a random selection of featureless windows had been performed in step (d).

14. A method according to claim 13, wherein the correction in step (e)(ii) is applied by multiplying the combined variability measure by a constant value selected from a lookup table.

15. A method according to claim 10, wherein the signal comprises an image frame.

16. A method according to claim 10, further comprising steps of identifying subregions of the third plurality of windows, calculating a measure of variability in each of the subregions, and comparing the measures of variability for the subregions to the measures of variability for the selected windows that include said subregions, and wherein the level of noise in the signal also is based on said comparisons.

17. A method for estimating noise in a signal, comprising:
(a) dividing a signal so as to form a plurality of windows, each of said windows comprising a plurality of data samples;
(b) calculating a measure of variability in each of the windows;
(c) clustering the plurality of windows based on similarities in their calculated measures of variability;
(d) identifying a target cluster;
(e) selecting at least one of the windows from the target cluster only; and
(f) estimating a level of noise in the signal by using the calculated measure of variability for each of the selected windows only.

18. A method according to claim 17, wherein said estimating step (f) comprises:
(i) combining the calculated measures of variability for all of the selected windows only; and
(ii) applying a correction in order to estimate a result that would have been obtained if a random selection of featureless windows had been performed in step (e).

19. A method according to claim 17, wherein the target cluster is identified in step (d) as the cluster formed in step (c) having the lowest measures of variability.

20. A method according to claim 17, wherein the target cluster is identified in step (d) based on its order of ranking compared to the other clusters in terms of lowest measures of variability, but wherein the target cluster is not the cluster having the lowest measures of variability.
